(19) United States
(12) Patent Application Publication
(10) Pub. No.: US 2007/0110945 A1
(43) Pub. Date: May 17, 2007

(54) High contrast optical information carrier

(76) Inventor: Milan Saalmink, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/573,742

(22) PCT Filed: Sep. 21, 2004
(86) PCT No.: PCT/IB04/51803

§ 371 Date: Oct. 24, 2006

(51) Int. Cl. B32B 3/02

(52) U.S. Cl. 428/64.1; 428/64.4

(57) ABSTRACT

The invention relates to an optical information carrier for carrying information to be read out by means of an optical beam (9). It is an object of the invention to provide information carriers with higher contrast This object is achieved by an information carrier comprising at least one information layer with cavities (4) having a width of 50 μm or less and with lands (5) between said cavities (4), smaller width (A) than depth (B), and optically active material (7) deposited on said lands (5) adapted to show an optical signal, when being stimulated by said optical beam (9).

The present invention relates to an optical information carrier and to a device and a corresponding method for manufacturing such an optical information carrier.

Optical information carriers are widely used nowadays. However, their data capacity is running towards a physical limit. A way to increase the data capacity is to increase the number of layers. Currently, existing DVD technology is extended to several layers. However, due to intrinsic reflection of the individual layers, the total number of layers will still be limited. Alternative technologies, such as fluorescent multi-layer technologies, offer a way to circumvent that problem.

U.S. Pat. No. 5,370,970 describes a disc with fluorescent material. The information is stored using an array of pits and lands, which are produced by common processing techniques such as injection moulding or embossing. Fluorescent data layers are produced by using a deposition material containing a fluorescent functionality, e.g., a fluorescent dye. The material is deposited by using common deposition techniques such as spin coating, doctor blading, dip-coating or vapour deposition. The fluorescent material is supposed to be deposited in the pits. The problem of the described disc is that applying a mixture of matrix material and dye material using common processing techniques, e.g., spin coating, both the lands and pits are covered. This is unwanted as a large contrast between lands and pits is of major importance, for instance, to obtain a sufficiently high data rate. The contrast obtained by spin coating is approximately 1.5, this is far too low for a fast read out of the system.

It is therefore an object of the present invention to provide an optical information carrier having a high contrast It is further object of the invention to provide a device and a corresponding method for manufacturing an information carrier having a high contrast.

The first object is achieved according to the present invention by an optical information carrier for carrying information to be read out by means of an optical beam, comprising at least one information layer with cavities having a width of 50 μm or less and with lands between said cavities, wherein said cavities have a smaller width than depth, and optically active material deposited on said lands to show an optical signal, when being stimulated by said optical beam.

According to the invention optically active material is deposited on the lands and preferably not in the cavities of the information layer. This is exactly the opposite compared to the prior art as described above. The invention relates to ROM (read only memory) and WORM (write once read many) applications. In ROM applications the cavities are usually called pits, and in WORM applications the cavities are usually called grooves.

Surprisingly, it was found out that with common deposition techniques it is possible to deposit optically active material on the lands of a structured substrate, if the cavities of the structured substrate have a width of 50 μm or less, preferably 10 μm or less, wherein the cavities have a smaller width than depth. Deposition on the lands but not, or hardly, in the cavities can be achieved by setting certain parameter values at the deposition device and by running the deposition process by means of the set deposition device and by depositing optically active material on a structured substrate having these narrow cavities. The surface should not be an ideal wetting surface. Thus, the idea of the invention to improve the contrast is to narrow the width of the cavities and to increase the ratio depth to width compared to the prior art as described above, and to choose certain parameter values for the deposition device in the manufacturing process.

In a WORM application grooves have a small width but a great length extending along a longitudinal direction of the grooves. Across the longitudinal direction of the grooves, the grooves can be located next to each other forming the lands between each other. Grooves can even circulate a center of a disc, e.g., resulting in a very large length. In a ROM application the pits have a small width, too. Their length can be larger than their width, but it is usually of the same dimension. In the longitudinal direction pits can be located behind each other, and across the longitudinal direction pits can be located next to each other. Lands are formed between the pits along and across the longitudinal direction. In a preferred embodiment both the length and the width are shorter than 50 μm, preferably less than 10 μm, most preferably approximately 0.5 μm.

Optically active material is deposited on the lands by common techniques like spin coating or dip coating. Using spin coating the optically active material is applied to the top surface of the structured substrate in a liquid form, e.g., dissolved in a solvent. The liquid is spread as a film over the top surface of the structured substrate and bulges over the narrow cavities with a width of 50 μm or less, preferably 10 μm or less, most preferably 0.5 μm, without creeping inside them. A rotation frequency of around 200 rpm and more is applied to the structured substrate covered with the film opening the film over each cavity. It is also possible to apply dip coating as a different deposition technique to the structured substrate having cavities with a width of less than 50 μm, preferably 10 μm. In this case the structured substrate is dipped into the liquid and the pull out speed is chosen to be around 1 cm/s or higher, preferably. In a ROM application the pits can have both a length and width of 50 μm or less, preferably 10 μm or less.

Preferably, all optically active material is deposited on the lands and no optically active material is deposited in the cavities. Thus, the intensity of an optical signal emitted by the lands stimulated by an optical beam is much higher than the intensity of an optical signal emitted by the cavities stimulated by the optical beam. Thus, the contrast of the information carrier increases compared to the prior art.

In a preferred embodiment of the invention the cavities contain no optically active material. That is, the contrast of an information carrier in this embodiment is improved, additionally.

It was also found out that using cavities having a smaller width than depth, hardly any optically active material enters the bottom of the cavities during deposition of the optically active material on a top surface of the structured substrate in the manufacturing process. The ratio of depth divided by width of a cavity is called aspect ratio, hereinafter.

Due to the high aspect ratio proposed according to the present invention, the surface tension effects of the deposited material prevent the deposited material from entering the cavities. Furthermore, air will be trapped in the cavities, especially pits, disabling the deposited material from reaching the bottom. Apart from the above mentioned techniques also doctor blading and vapour deposition can be applied on a structured substrate having cavities with a high aspect ratio.

Preferably, the ratio of said depth to said width is larger than 1.5, preferably in a range from 1.5 to 2.5. This value of the aspect ratio fulfils the contradicting requirements of a large aspect ratio and a thin information layer. Each information layer should be as thin as possible to locate as many information layers in an information carrier of a given thickness as possible.

Preferably, optically active material contains fluorescent material. Fluorescent material is widely used in optical storage technologies. Known and commercially available optically active materials can consist of a mixture of a matrix material and a dye material. Matrix material is preferably material of the group including: polyvinylacetal, poly(methyl)acrylate, polyether, polyester, polycarbonate or polyalcohol, and the dye material is preferably material of the group including: xanthene, acridine, oxazine or coumarin. These materials are widely used and therefore proven. They can also be used in the optical information carrier according to the present invention keeping production and development costs low.

The deposition of optically active material can optionally be improved by using certain techniques, e.g., matching the physical or chemical properties of the mixture that has to be deposited with those of the used substrate, choosing materials with the same polarity, applying a (non)-wetting layer, or using a plasma treatment to modify the lands. Subsequently, the lands can be treated by etching, washing or depositing an additional cover layer.

Advantageously, an optical information carrier contains a plurality of information layers containing cavities and lands and spacer layers separating successive information layers. Multi-layer optical information carriers have higher capacities than single-layer optical information carriers. Using fluorescent material a large number of information layers can be arranged above each other. Multi-layer information carriers according to the invention have larger contrast compared to known multi-layer optical information carriers.

The object of the invention is also achieved by a device for manufacturing an optical information carrier as claimed in claim 11 and by a method for manufacturing an optical information carrier as claimed in claim 14, said method comprising the steps of forming cavities having a width of 50 μm or less and forming lands between said cavities in said at least one information layer, and depositing optically active material on said lands adapted to show an optical signal, when being stimulated by an optical beam. Preferably, spin coating and dip coating are used as deposition techniques for depositing the optically active material on the lands.

Preferred embodiments of the device for manufacturing and the manufacturing method are claimed in dependent claims.

The invention will now be explained in more detail with reference to the drawings, in which:

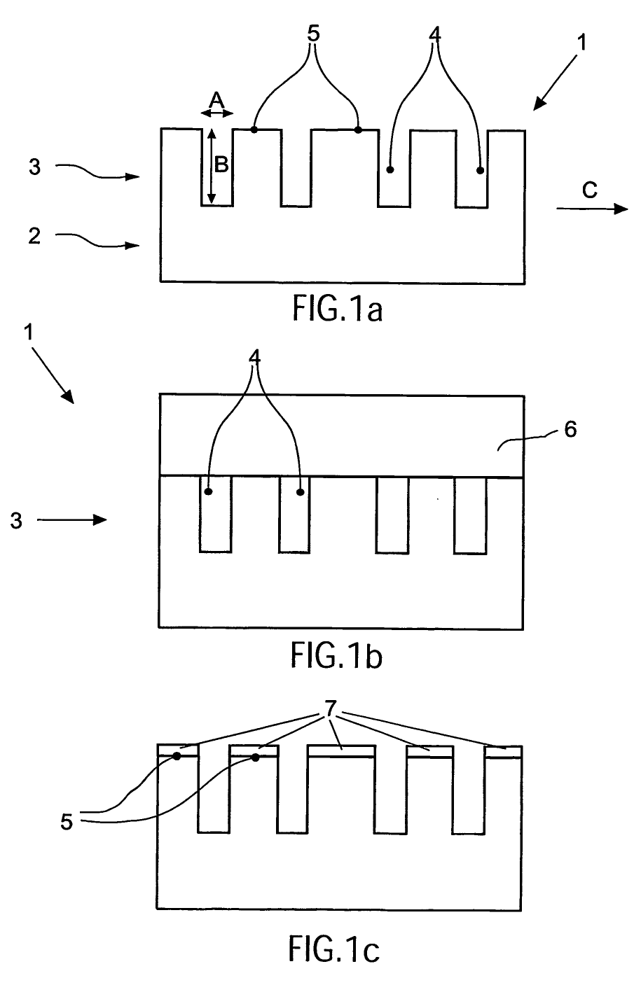

FIGS. 1a-1c show three steps of a manufacturing method for a WORM disc according to the invention,

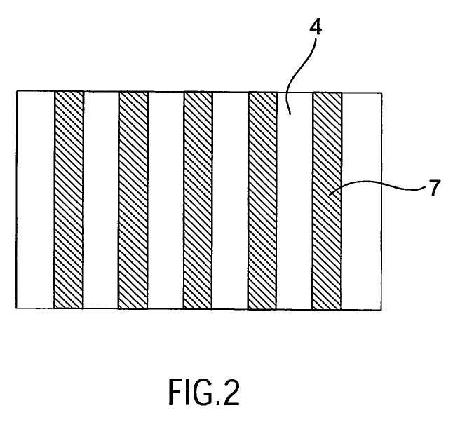

FIG. 2 shows a top view of the disc in FIG. 1c,

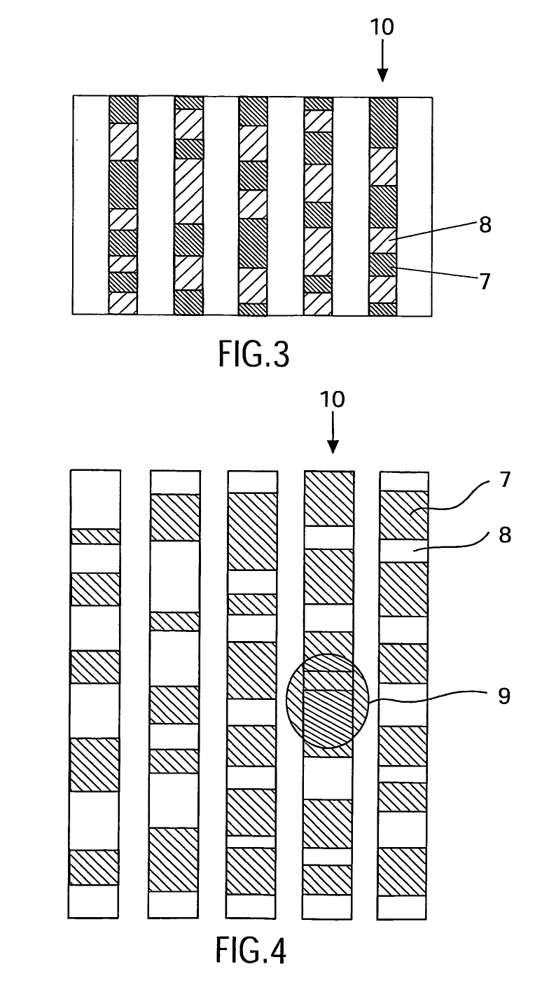

FIG. 3 shows a recorded WORM disc according to FIG. 2, and

FIG. 4 shows a reading beam passing along a track of the recorded disc in FIG. 3.

FIG. 1a shows a first step in a manufacturing process of a WORM disc according to the invention. A structured substrate I as shown in FIG. 1a will become part of an information layer of the disc. FIG. 1a shows a cut-out of a cross-section of the structured substrate 1 along a diameter of the disc.

The information layer extends along the plane of the disc. The structured substrate 1 contains a continuous basis 2 extending along the plane of the disc and a top 3 in which grooves 4 are placed circulating a center C of the disc. Lands 5 are constituted between adjacent grooves 4 and they are circulating the center C of the disc, consequently. The center C of the disc is not shown, but the location is indicated by the corresponding arrow. The cut-out in FIG. 1a shows five lands 5 and four grooves 4.

The grooves 4 have a depth B and a lateral width A. The ratio B/A is called aspect ratio. According to the invention the width is selected to be approximately 0.5 μm (or less). The grooves 4 are shaped rectangular perpendicular to the direction of circulation. The lateral width A and the depth B of the grooves 4 is constant along the direction of circulation. The lateral width of a land 5 is the distance between the inward edge of an outward groove and the outward edge of the adjacent inward groove.

FIG. 1b shows a second step in the manufacturing process of the WORM disc according to the invention. On the top 3 of the substrate an optically active material layer 6 containing a matrix material and a fluorescent dye material is deposited. The matrix material can be polyvinylacetal, poly(methyl)acrylate, polyether, polyester, polycarbonate or polyalcohol. The fluorescent dye can be xanthene, acridine, oxazine or coumarin dye.

The optically active material can be deposited on the top 3 of the substrate 1 by, e.g., spin coating. That is, the optically active material is dissolved in a solvent. Then it is applied on the horizontally positioned structured substrate I forming a layer of dissolved matrix dye mixture 6 covering the top 3 of the structured substrate 1. As a result of the application process there will be no matrix dye mixture 6 deposited in the grooves 4. One reason for this is that air will be trapped inside the grooves 4 disabling the deposited material 6 from reaching the bottom of these grooves 4, and furthermore, due to the small width the surface tension of the dissolved matrix dye mixture 6 also prevents the matrix dye mixture 6 from entering the grooves 4. The dissolved matrix dye mixture 6 bulges over the narrow groove 4 without entering the groove 4. FIG. 1b shows the described second step in the manufacturing method, where a layer of dissolved matrix dye mixture 6 is deposited on the top 3 of the substrate 1.

Subsequently, the substrate 1 with the applied dissolved matrix dye mixture 6 is rotated with a rotation frequency of around 2500 rpm or higher and a thin layer of dissolved matrix dye mixture will be left on the lands 5. The solvent will evaporate and leave a deposited layer 7 of matrix dye mixture on the lands 5. The result of the manufacturing method according to the invention is shown in FIG. 1c.

Other known coating methods can be used for depositing a layer 7 of matrix dye mixture on the lands 5. A different technique is doctor blading. In this method optically active material is applied to the substrate 1 and a blade positioned in a defined distance above the top 3 of the substrate 1 is moved parallel over the top 3 of the substrate 1 producing deposited layers 7 on the lands 5. This deposition method is applied to cavities having an aspect ratio of 1.5 or higher, preferably in a range from 1.5 to 2.5.

A further technique is dip coating, that is, the top 3 of the substrate 1 is simply dipped into a solution containing the optically active material and afterwards the substrate 1 is pulled out. For a structured substrate 1 having grooves with a width (A) of less than 50 μm, preferably 0.5 μm. Consequently, a thin layer 7 will deposit on the lands 5 of the substrate 1. The thickness of the deposited layer 7 can be varied by the pull out speed of the substrate 1.

Finally vapour deposition can be chosen to deposit a layer 7 on the lands 5, that is, the to be applied material is heated and evaporates. The vapour will be deposited in a solid state on the lands 5 of the substrate 1. This deposition method is applied to cavities having an aspect ratio of 1.5 or higher, preferably in a range from 1.5 to 2.5.

The connection between the lands 5 and the deposited layer 7 can be improved by matching the physical or chemical properties of the matrix dye mixture 6 and the substrate 1, e.g., by choosing materials with the same polarity. It is also possible to apply a wetting layer to the lands 5 resulting in a wetting effect for the dissolved matrix dye mixture 6. In this way the adhesion and/or amount of applied material can be controlled. A polar mono-layer is a wetting layer, e.g. The lands 5 can also be modified by a plasma treatment Oxygen plasma can be used in a plasma treatment. One effect of the oxygen plasma treatment is to make the lands more polar. A second effect of a plasma can be to roughen the lands 5 supporting the adhesion. In addition, subsequent treatment may be optionally employed to further modify the created lands 5. The lands 5 can be etched, washed or an additional cover layer can be deposited on the lands 5.

The above described manufacturing method can produce WORM discs, i.e., not recorded discs. But the identical method can also be used for manufacturing ROM discs. WORM and ROM discs differ in the length of the cavities, namely grooves 4 and pits 4, respectively. FIG. 2 shows the top view of FIG. 1c and an unwritten structure of the deposited layer 7 and the empty grooves 4 between adjacent deposited layers 7.

Recording of information on a WORM disc can be achieved by degrading selected section 8 of the deposited layer 7, e.g., by heating the selected sections 8 by means of a writing laser beam above a degrading temperature of the matrix dye mixture as illustrated in FIG. 3. The degrading sections 8 loose their fluorescent characteristics, i.e., stimulating degraded sections 8 with a reading laser beam does not result in fluorescent emission of said degraded section 8.

A reading method is explained with respect to FIG. 4. FIG. 4 shows five written tracks 10 containing deposited layers 7 and degraded sections 8. A focal spot 9 of a pulsed reading beam, which can also be a laser beam but with a different wavelength or lower intensity than the writing beam, passes in FIG. 4 from the bottom to the top along the track 10. Each time the reading beam pulse hits a deposited layer 7 the laser light is absorbed and fluorescent light is emitted. The fluorescent light can be collected by an appropriate collector and can be evaluated, afterwards. Each time the reading beam pulse hits a degraded section 8 no fluorescent light is emitted. Therefore, no fluorescent light can be collected and no signal is detected. The sequence of fluorescent signals and no signals correlated with the pulse frequency of the reading beam is the encoded information stored in the information layer.

In a particular embodiment of a ROM disc according to the invention pits have been used having a length of about 1.6 μm, a width of about 0.5 μm and a height of about 1 μm. Thus, the aspect ratio is about 2. To obtain a ROM disc a structured substrate containing pits with different lengths is manufactured, e.g., by means of a stamper. The information is encoded in the different length of the pits.

Discs according to the prior art have a low contrast. It is an object of the invention to improve the contrast of said discs. This object is achieved by providing structured substrates 1 with cavities 4 having a smaller width compared to the art and by choosing certain parameter values for known deposition techniques. The deposition techniques applied to these new structures result in a deposition of fluorescent material 7 on the lands 5. Hardly any fluorescent material 7 is deposited on the bottom of the cavities 4 resulting in a higher contrast.

1. Optical information carrier for carrying information to be read out by means of an optical beam (9) comprising:
at least one information layer with cavities (4) having a width (A) of 50 μm or less and with lands (5) between said cavities (4), wherein said cavities (4) have a smaller width (A) than depth (B), and
optically active material (7) deposited on said lands (5) adapted to show an optical signal, when being stimulated by said optical beam (9).

2. Optical information carrier as claimed in claim 1, characterized in that said cavities (4) have a width (A) of 10 μm or less.

3. Optical information carrier as claimed in claim 1, characterized in that said cavities (4) contain no optically active material (7).

4. Optical information carrier as claimed in claim 1, characterized in that the ratio of said depth (B) to said width (A) is 1.5 or higher.

5. Optical information carrier as claimed in claim 4, characterized in that the ratio of said depth (B) to said width (A) is in a range from 1.5 to 2.5.

6. Optical information carrier as claimed in claim 1, characterized in that a cover layer is located between said lands (5) and said optically active material (7).

7. Optical information carrier as claimed in claim 1, characterized in that said optically active material (7) is fluorescent material.

8. Optical information carrier as claimed in claim 1, characterized in that said optically active material (7) contains a matrix material and a dye material.

9. Optical information carrier as claimed in claim 8, characterized in that said matrix material is a material of the group including: polyvinylacetal, poly(methyl)acrylate, polyether, polyester, polycarbonate or polyalcohol and said dye is a material of the group including: xanthene, acridine, oxazine or coumarin.

10. Optical information carrier as claimed in claim 1, characterized by a plurality of information layers containing cavities (4) and lands (5) and spacer layers separating successive information layers.

11. Device for manufacturing an optical information carrier having at least one information layer comprising:
means for forming cavities (4) having a width of 50 μm or less and for forming lands (5) between said cavities (4) in said at least one information layer, wherein said cavities (4) have a smaller width (A) than depth (B), and
means for depositing an optically active material (7) on said lands (5) adapted to show an optical signal, when being stimulated by an optical beam (9).

12. Device as claimed in claim 11, characterized by means for forming cavities (4) having a width of 10 μm or less.

13. Device as claimed in claim 11, characterized in that said means for forming cavities (4) and for forming lands (5) are adapted to form cavities having a smaller width (A) than depth (B).

14. Method for manufacturing an optical information carrier having at least one information layer comprising the steps of:
forming cavities (4) having a width of 50 μm or less and forming lands (5) between said cavities (4) in said at least one information layer, wherein said cavities (4) have a smaller width (A) than depth (B), and
depositing optically active material (7) on said lands (5) adapted to show an optical signal, when being stimulated by an optical beam (9).

15. Method as claimed in claim 14, characterized by forming cavities (4) having a width of 10 μm or less.

16. Method as claimed in claim 14, characterized by using spin coating with a rotation frequency of about 200 rpm and larger for depositing optically active material (7) on said lands (5).

17. Method as claimed in claim 16, characterized by applying a non-wetting layer, a plasma treatment, an etching or washing treatment to said lands (5), or depositing a cover layer on said lands (5) improving the connection between said lands (5) and said optically active material (7).
